(19) United States
(12) Patent Application Publication
(10) Pub. No.: US 2015/0321104 A1
(43) Pub. Date: Nov. 12, 2015

(54) SYSTEM, METHOD, AND COMPUTER READABLE RECORDING MEDIUM OF REGISTERING FRIEND IN GAME

(71) Applicant: NHN Entertainment Corporation, Seongnam-si (KR)

(72) Inventor: Seong Youn JOO, Seongnam-si (KR)

(21) Appl. No.: 14/802,367

(22) Filed: Jul. 17, 2015

Related U.S. Application Data
(62) Division of application No. 13/495,422, filed on Jun. 13, 2012.

(30) Foreign Application Priority Data
Jun. 16, 2011 (KR) 10-2011-0058659

(51) Int. Cl. A63F 13/795

(52) U.S. Cl. CPC A63F 13/795

(57) ABSTRACT

A method, a system and a computer readable recording medium for registering a friend in a game. The method of registering a friend in a game, performed by a game service platform server includes: registering at least a member as a game friend among members who have joined the game managed by the game service platform server, based on friend registration request information received from a user terminal; providing the user terminal with information on the game currently accessed by the member registered as a friend; and providing the user terminal with information needed to execute the game, in response to a receipt of game selection information indicating that the game friend has selected the currently accessed game from the user terminal.

### CROSS REFERENCE TO RELATED APPLICATIONS

This application is a divisional of U.S. patent application Ser. No. 13/495,422, filed on Jun. 13, 2012, and claims priority from and the benefit of Korean Patent Application No. 10-2011-0058659, filed on Jun. 16, 2011, which are both hereby incorporated by reference for all purposes as if fully set forth herein.

### BACKGROUND

1. Field

Exemplary embodiments of the present invention relate to a method, a system and a computer readable recording medium for registering a friend in a game, and more specifically, to a method, a system and a computer readable recording medium for registering a friend in a game, in which acquaintances or non-acquaintances are registered as a friend in a variety of methods on a user terminal device, and individual games are progressed based on information on the registered friends.

2. Discussion of the Background

As the performance of latest smart phones is enhanced, many users tend to move from general cellular phones to smart phones. A smart phone is an intelligence cellular phone adding computer support capabilities to a cellular phone, which is added with personal digital assistant (PDA) functions, capacity to connect to Internet, moving image playback functions and the like while being faithful to original functions of the cellular phone, and has a variety of input methods and a touch screen, etc. to provide an interface to add further convenience to its use. In addition, a smart phone is connected to the Internet and computers with the support of capacity to wirelessly connect to Internet so as to perform functions of a terminal, such as an e-mail, World-Wide-Web (hereinafter, “web”) browsing, facsimile, banking, and a game. Meanwhile, a smart phone is equipped with a standardized operating system (OS) or a dedicated operating system in order to perform a variety of functions.

Like this, as a variety of functions can be implemented through various user terminal devices such as a smart phone, laptop, or tablet, a variety of dedicated application programs and contents operating within the user terminal device have been developed. In addition, as the functions of such a mobile terminal among the user terminal devices are improved, a large number of mobile games that users can enjoy in a variety of ways in an environment similar to the web have been developed. Accordingly, a lot of network games have also been developed to allow users who have connected to a network through a mobile terminal to connect and play the same game. At this point, a game client is generally mounted on the user terminal device such as a smart phone and connected to a game server through a wired or wireless communication network, so as to perform the corresponding game on the user terminal device.

Meanwhile, a variety of user terminal devices provide various application such as social network service (SNS) programs for making relationships among users, beyond the functions of a cellular phone and/or functions of simply providing information. Accordingly, it is required to develop a method capable of constructing human networks related to games and forming new communities through the human networks not only by simply providing a game to individual users but also by closely connecting game users even in the network games.

The above information disclosed in this Background section is only for enhancement of understanding of the background of the invention, and therefore, it may contain information that does not form any part of the prior art nor what the prior art may suggest to a person or ordinary skill in the art.

### SUMMARY

Accordingly, exemplary embodiments of the present invention are conceived to solve the problems in the prior art operated as described above. Exemplary embodiments of the present invention provide a method and a system for registering a friend in a game, which provide a game service platform for managing game services in association with a plurality of games in a personalized user terminal device, extract acquaintances through the provided game service platform, register the extracted acquaintances as a friend, and induce progress of the game with the registered friends.

Exemplary embodiments of the present invention also provide a method and a system for registering a friend in a game, which provide a game service platform for managing game services in association with a plurality of games in a personalized user terminal device, recommend non-acquaintances who use the game through the provided game service platform, register the recommended non-acquaintances as a friend, and induce progress of the game with the registered friends.

Exemplary embodiments of the present invention provide a method and a system for registering a friend in a game, which provide a game service platform for managing game services in association with a plurality of games in a personalized user terminal device, construct a social network with a group of registered friends through the provided game service platform, and provide a variety of additional services.

Additional features of the invention will be set forth in the description which follows, and in part will be apparent from the description, or may be learned by practice of the invention.

An exemplary embodiment of the present invention discloses a method of registering a friend in a game, performed by a game service platform server, the method comprising: registering, by the game service platform server, one member as a game friend among members who have joined the game managed by the game service platform server, based on friend registration request information received from a user terminal; providing the user terminal with information on the game currently accessed by the member registered as a friend; and providing the user terminal with information needed to execute the game, if game selection information indicating that the game friend has selected the currently accessed game is received from the user terminal, wherein the user terminal executes a game service platform which manages the game and provides the friend registration request information and the game selection information through the game service platform.

An exemplary embodiment of the present invention also discloses a system for registering a friend in a game, the system including: a user terminal configured to execute a game service platform which manages the game and providing friend registration request information and game selection information through the game service platform; and a game service platform server configured to register at least a member as a game friend among members who have joined the game managed by the game service platform server, based on the friend registration request information received from the user terminal; to provide the user terminal with information on the game currently accessed by the member registered as a friend; and to provide the user terminal with information needed to execute the game, in response to a receipt of the game selection information indicating that the game friend has selected the currently accessed game from the user terminal.

An exemplary embodiment of the present invention also discloses a method of executing a game through registration of a friend, performed by a game service platform server managing a plurality of games, the method including: receiving a request for registering a game friend based on an address book from a user terminal; searching for address book data stored in the user terminal; determining, by the game service platform server, whether or not a search target registered in the searched address book data has joined at least a game service among the plurality of games managed by the game service platform server; and registering the search target as the game friend, in response to the determination that the search target has joined the game service.

An exemplary embodiment of the present invention also discloses a method of executing a game through registration of a friend, performed by a game service platform server managing a plurality of games, the method including: receiving a request for adding a rival friend from a user terminal; extracting information, by the game service platform server, on at least one recommendable member matched to conditions of a recommendation algorithm previously agreed with the user, from the members who have joined at least a game service among the plurality of games managed by the game service platform server, and providing the user terminal with the information on recommendable members; and in response to a selection of a member from the provided member information, registering the selected member as the game friend.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a view showing the concept of a game service platform according to an exemplary embodiment of the present invention.

FIG. 2 is a view showing a screen of a game service platform on a smart phone according to an exemplary embodiment of the present invention.

FIG. 3 is a view showing a system for registering a friend in a game according to an exemplary embodiment of the present invention.

FIG. 4 is a view showing the detailed structure of a game service platform server and a database server according to an exemplary embodiment of the present invention.

FIG. 5 is a flowchart illustrating a procedure of registering a friend in a game according to an exemplary embodiment of the present invention.

FIG. 6 is a flowchart illustrating a procedure of automatically registering a friend from an address book according to an exemplary embodiment of the present invention.

FIG. 7 is a flowchart illustrating a procedure of automatically registering an SNS friend according to an exemplary embodiment of the present invention.

FIG. 8 is a flowchart illustrating a procedure by which a user registers a person, as a friend, who added the user as a friend according to an exemplary embodiment of the present invention.

FIG. 9 is a flowchart illustrating a procedure of registering a friend by user search according to an exemplary embodiment of the present invention.

FIG. 10 is a flowchart illustrating a procedure of recommending a friend at a server according to an exemplary embodiment of the present invention.

FIG. 11 is a view showing a screen for automatically registering a friend from an address book on a smart phone according to an exemplary embodiment of the present invention.

FIG. 12 is a view showing a screen for automatically registering an SNS friend on a smart phone according to an exemplary embodiment of the present invention.

FIG. 13 is a view showing a screen in which a user registers a person, as a friend, who added the user as a friend on a smart phone according to an exemplary embodiment of the present invention.

FIG. 14 is a view showing a screen for registering a friend by user search on a smart phone according to an exemplary embodiment of the present invention.

FIG. 15 is a view showing a screen for recommending a friend on a smart phone according to an exemplary embodiment of the present invention.

FIG. 16 is a view showing a screen for executing a game through a list of registered friends according to an exemplary embodiment of the present invention.

### DETAILED DESCRIPTION OF THE ILLUSTRATED EMBODIMENTS

In the following detailed description, references are made to the accompanying drawings that show, by way of illustration, specific exemplary embodiments in which the invention may be practiced. These exemplary embodiments are described in sufficient detail to enable those skilled in the art to practice the invention. It is to be understood that the various exemplary embodiments of the invention, although different, are not necessarily mutually exclusive. For example, a particular feature, structure, or characteristic described herein, in connection with one exemplary embodiment, may be implemented within other exemplary embodiments without departing from the spirit and scope of the invention. In addition, it is to be understood that the location or arrangement of individual elements within each disclosed exemplary embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numbers refer to the same or similar functionality throughout the several views. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Exemplary embodiments of the present invention propose a method and a system for registering a friend in a game, in which users playing a game provided through a user terminal device are registered as a friend, and a game community is created based on the registered friends.

At this point, according to an exemplary embodiment of the present invention, a game service platform associated with a plurality of games is provided, and a game friend can be registered in a variety of methods through the provided game service platform. Accordingly, a game accessing state of a friend can be confirmed in real-time using information on the registered game friend, and thus the user may immediately participate in the game currently executed by the game friend.

In addition, according to an exemplary embodiment of the present invention, a game friend appropriate for the user can be recommended through the provided game service platform, and the user may select and register the recommended friend as a user's game friend or participate in the game currently executed by the recommended friend.

Meanwhile, it is described below that the exemplary embodiments of the present invention are applied to a ‘smart phone’ for the clarity of explanation. However, exemplary embodiments of the present invention can be applied to any user terminal device that can provide the functions of the exemplary embodiments of the present invention, as well as a smart phone. For example, the exemplary embodiments of the present invention can be applied to all kinds of user terminal devices capable of executing an application, including not only mobile terminals such as a laptop computer, a digital broadcasting terminal, a personal digital assistant (PDA), a portable multimedia player (PMP), and a navigation device, as well as cellular phone, but also fixed terminals such as a computer, and a TV.

In addition, in this specification, the terminology ‘game service platform’ is the broadest concept referring to a software framework (including an application program framework) which provides integrated management of information and services related to each game in association with at least a game program (preferably, a plurality of game programs) according to an exemplary embodiment of the present invention. That is, the game service platform is a basis for executing individual game software, and the execution of a program may not be restricted to a specific operating system through the game service platform.

In addition, in this specification, the terminology ‘acquaintance’ means a person with whom a client terminal user executing the game service platform according to an exemplary embodiment of the present invention establishes a relation through a certain channel (for example, stores the person in the address book of a terminal, or registers the person in a social network service (SNS) as a friend, etc.), and the connection relation is stored in computer readable memory. In addition, the terminology ‘non-acquaintance’ is a concept opposed to the ‘acquaintance’, which means a person with whom a relation with the client terminal user executing the game service platform according to an exemplary embodiment of the present invention does not establish through any channel, and the connection relation is not stored in the computer readable memory. In the exemplary embodiments of the present invention, the acquaintance and the non-acquaintance are distinguished and separately registered as game friends through different methods.

In addition, the game service platform is mounted on a smart phone, manages a plurality of game software in an integrated manner, and provides a variety of services in association with each of the game software. For example, the game service platform provides an interface allowing each user to access each game, as well as a variety of records and statistic data related to the game. In addition, the game service platform provides a variety of methods for extracting acquaintances and recommending non-acquaintances through a game according to an exemplary embodiment of the present invention, combines groups of friends registered through the methods in a social network, and provides a variety of additional services.

Hereinafter, exemplary embodiments of the present invention will be described in detail with reference to the accompanying drawings so that those skilled in the art may easily embody the exemplary embodiments of the present invention.

Concept of Game Service Platform

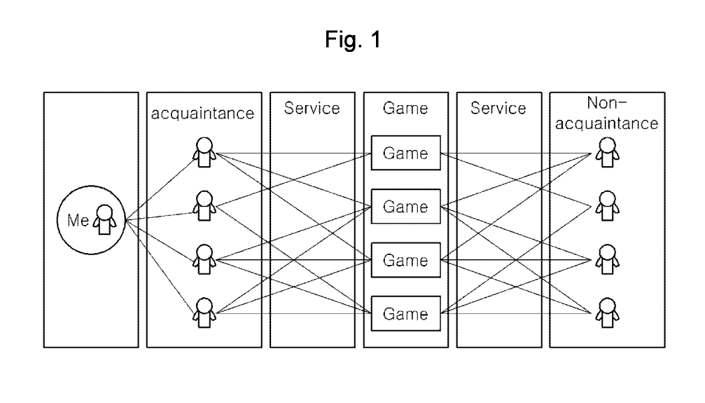

FIG. 1 is a view showing the concept of a game service platform according to an exemplary embodiment of the present invention. As shown in FIG. 1, the game service platform according to an exemplary embodiment of the present invention provides a basis for a service user to easily access a game through an acquaintance and further easily make friends with a non-acquaintance through the game. That is, the service user may register his or her acquaintance as a friend, and may access a game played by an acquaintance through the registered game friend or play the game together with the acquaintance. In addition, the service user may establish a social network based on a specific game by playing the game together with a non-acquaintance who has an access to the game or registering the non-acquaintance who has played the game together with the user as a game friend.

Accordingly, since the service user, the service and the game are closely interconnected through the game service platform according to an exemplary embodiment of the present invention, the relationship with the service users is extended, thereby enhancing amusement. Furthermore, game-oriented services that will keep experiences and values can be provided through the game service platform according to an exemplary embodiment of the present invention.

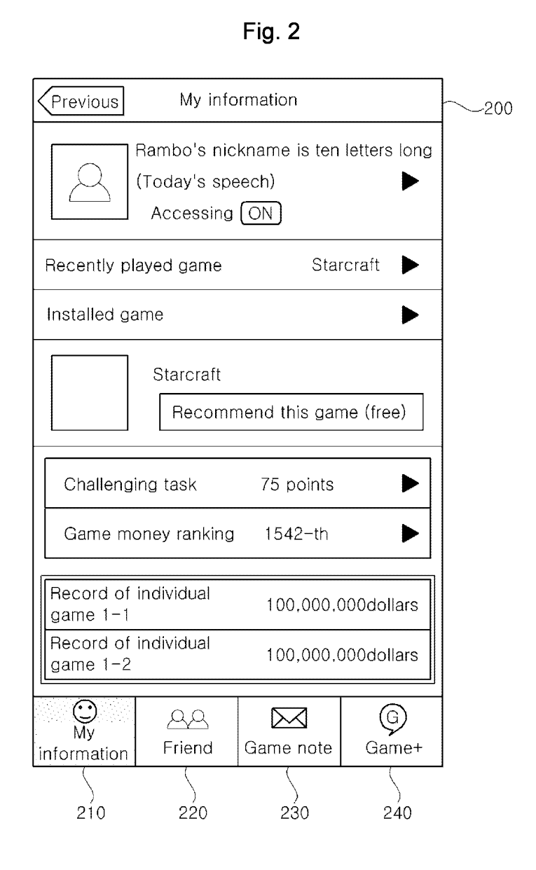

FIG. 2 is a view showing a screen of a game service platform on a smart phone according to an exemplary embodiment of the present invention. As shown in FIG. 2, the screen 200 of the game service platform, provided by a smart phone, includes a variety of menus and information related to a game, and specific items of each menu may operate in connection with a plurality of games associated with the game service platform.

The main menu provided by the game service platform may include entries such as My Information 210, Friend 220, Game Note 230, Game Plus (Game+) 240 and the like at the lower portion of the screen. If the My Information 210 is selected from the main menu, the screen is switched to the home of the My Information 210, and a variety of information on a corresponding user who has joined a smart phone game service is displayed as shown in FIG. 2. For example, information such as a picture, a nickname, a connection state, recently played games, installed games, game titles, recommendation of this game, challenging tasks, a representative ranking, and records of each game can be displayed.

At this point, if a specific item is selected from the items listed above, a connected page for detailed information view or detailed selection is displayed. For example, if an arrow displayed on the right side of the nickname ‘Rambo's nickname is ten letters long’ at the upper portion is selected, the screen is switched to display a profile management screen that allows management of detailed information on a corresponding user, and the picture, the nickname or the like can be modified, or an SNS account such as Facebook™ can be registered through the switched profile management screen. In addition, an automatic login function can be set or released.

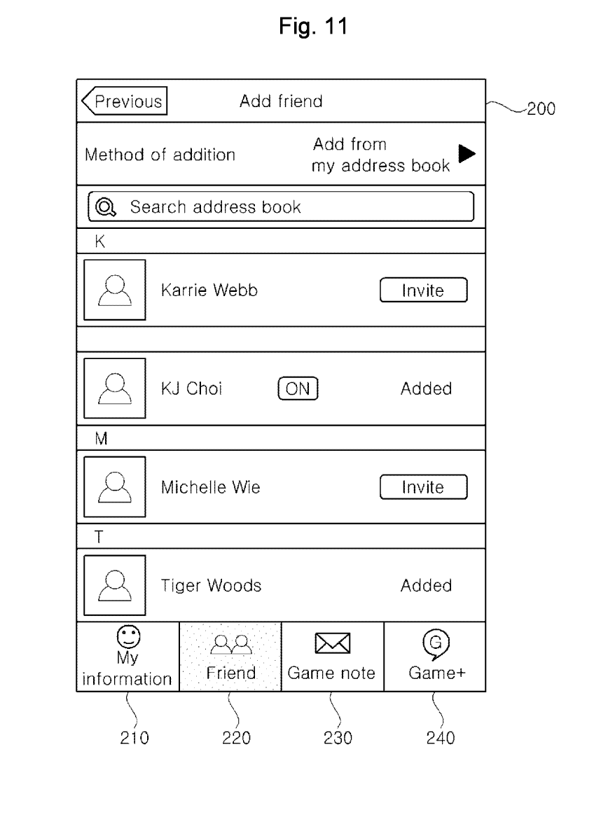

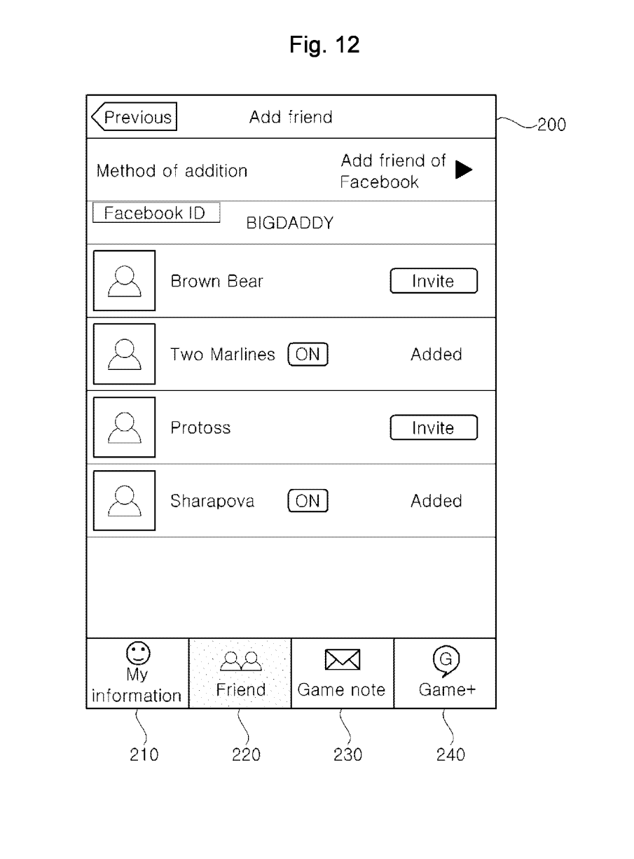

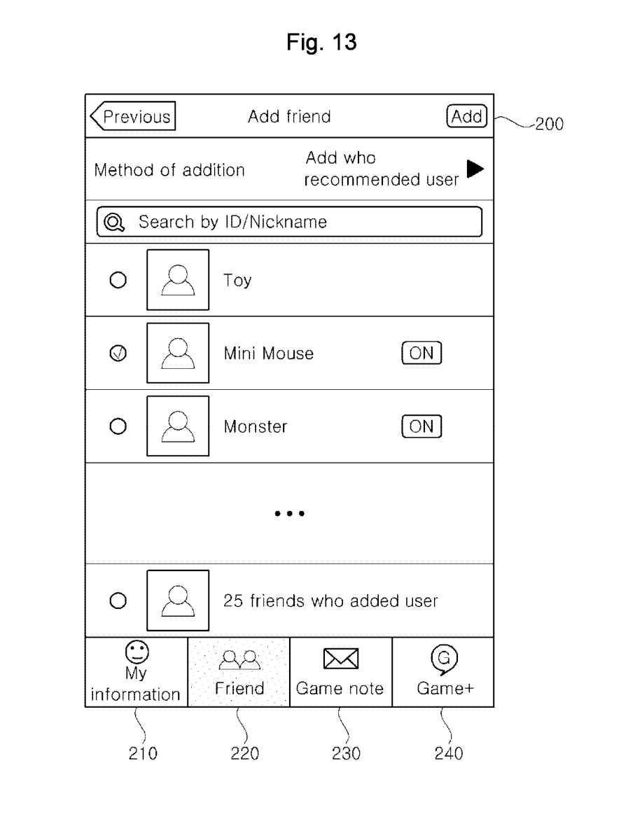

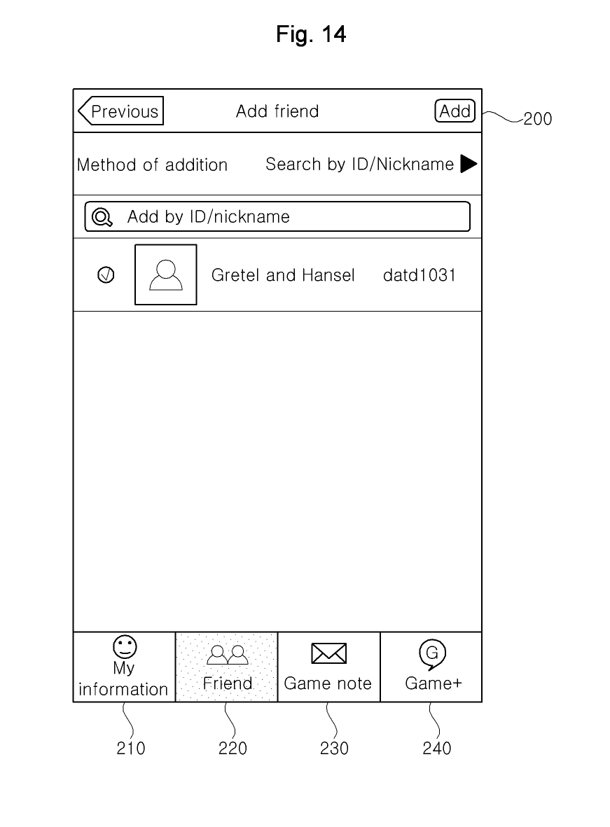

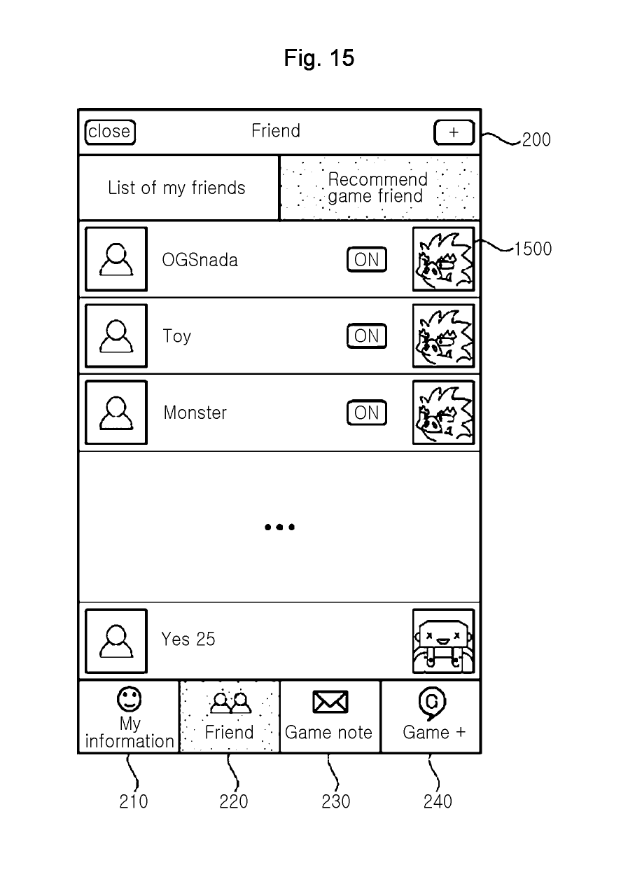

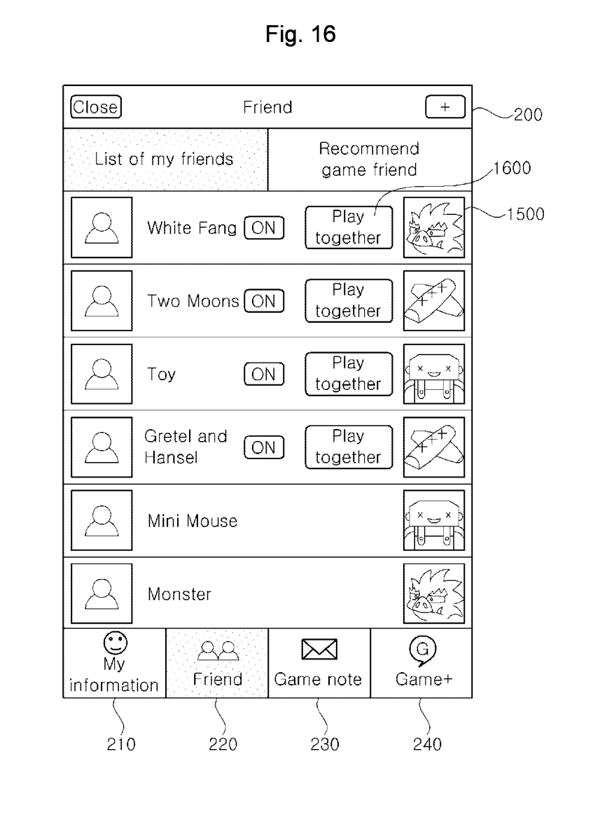

On the other hand, if the entry Friend 220 is selected from the main menu, a function of extracting a variety of information on acquaintances and recommending non-acquaintances is provided as shown in FIG. 11, FIG. 12, FIG. 13, FIG. 14, FIG. 15, and FIG. 16, which will be described below. Detailed descriptions thereof will be described below.

If the entry Game Note 230 is selected from the main menu, a function of sending a note to other registered game service users is performed.

Finally, if the entry Game Plus 240 is selected from the main menu, information on a variety of games associated with the game service platform is provided, and information such as a game advertisement banner, a game mobile web link, and a customer center can be additionally provided.

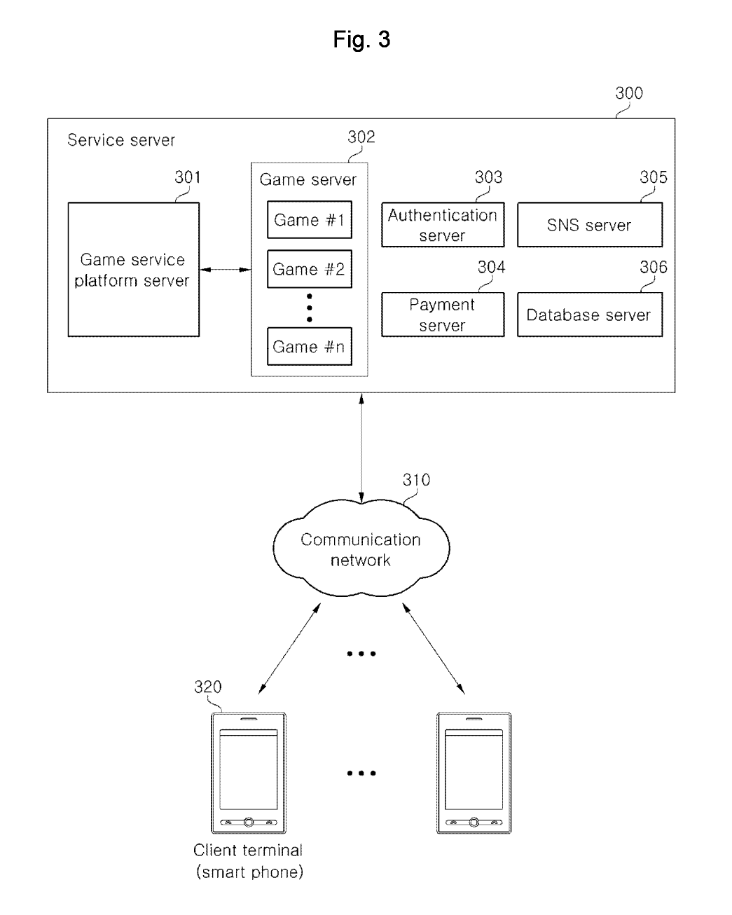

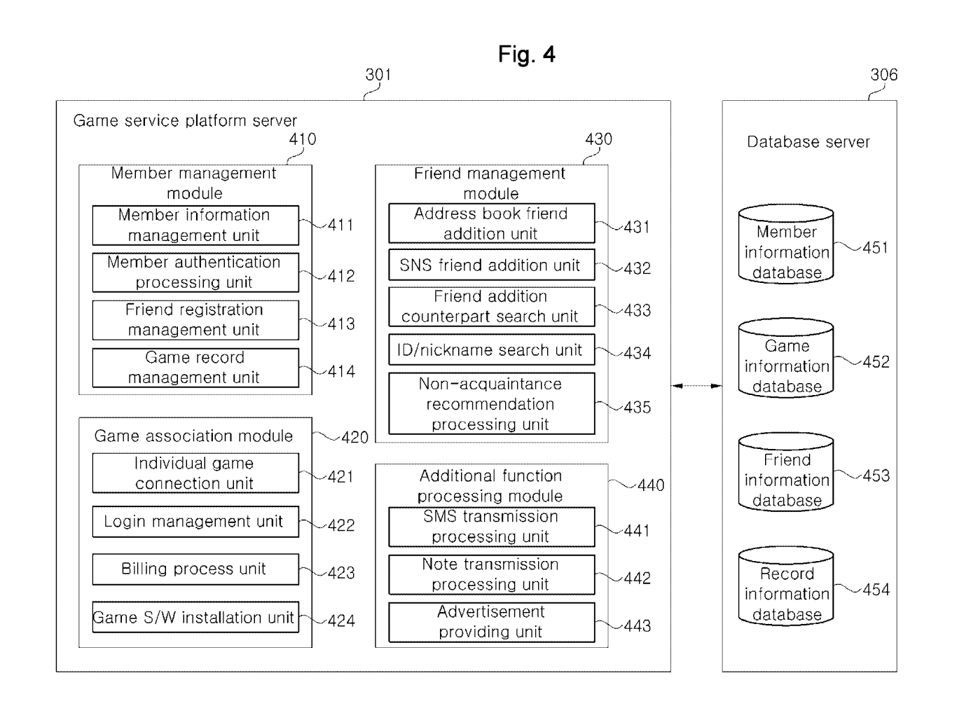

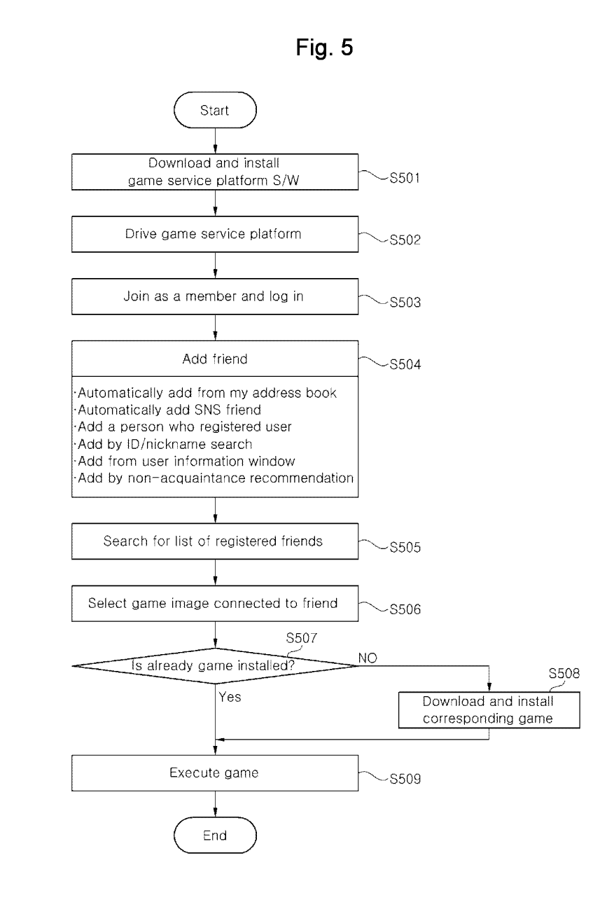

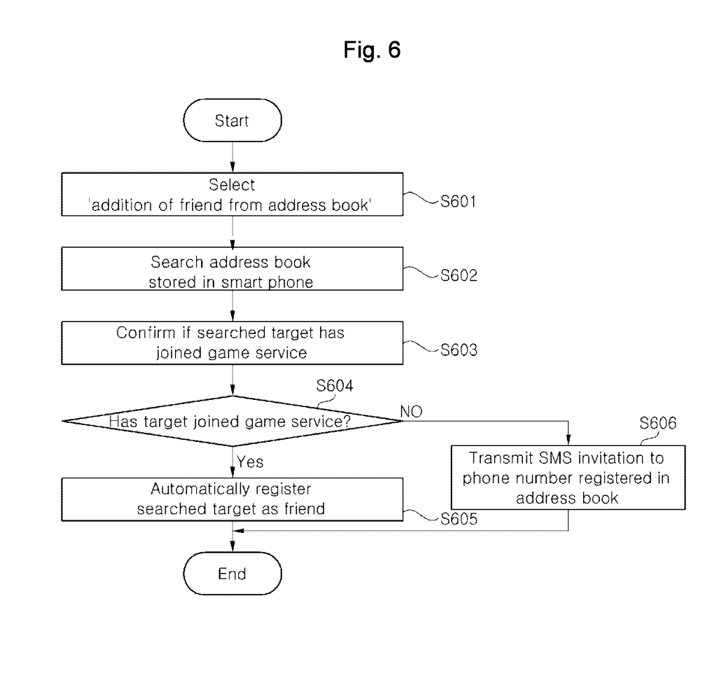

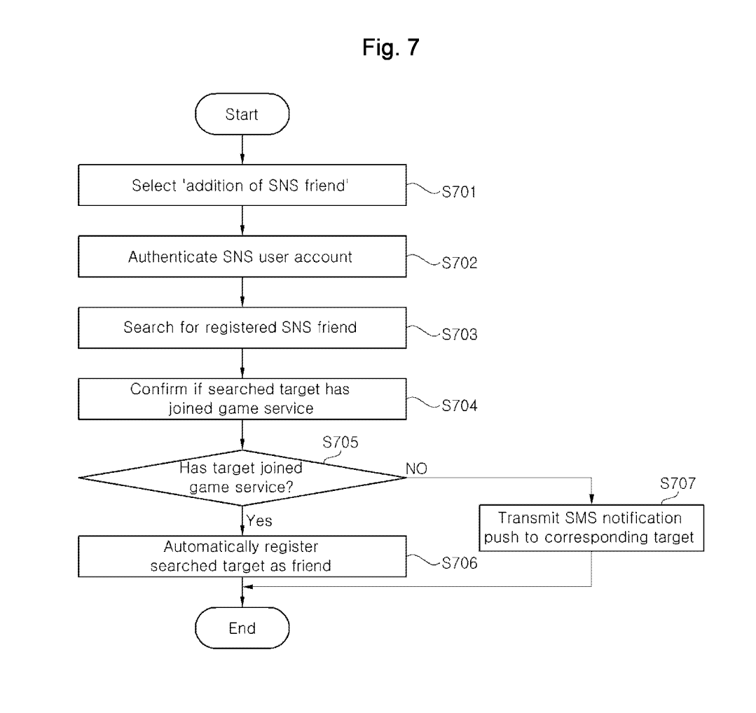

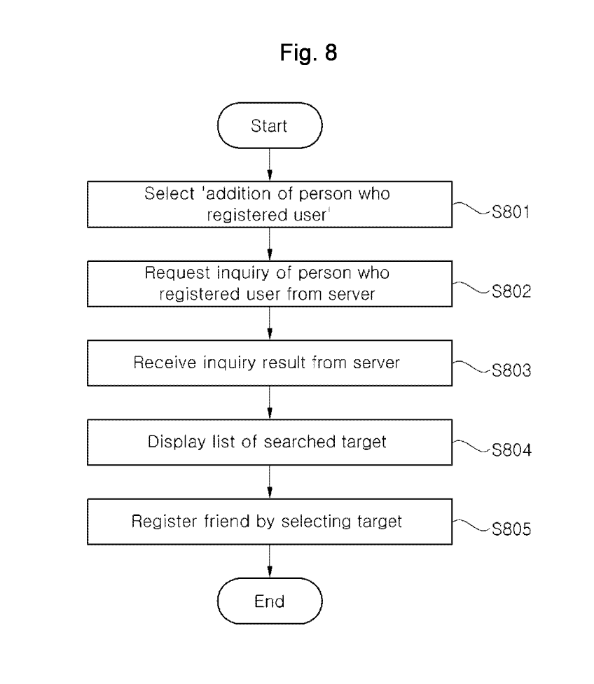

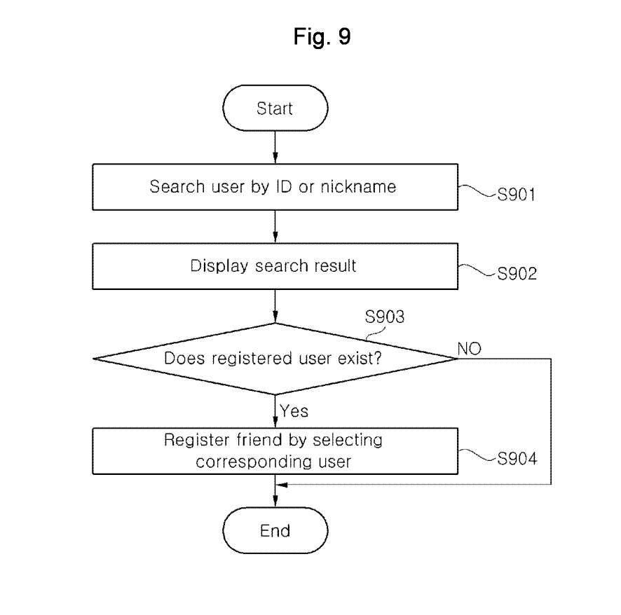

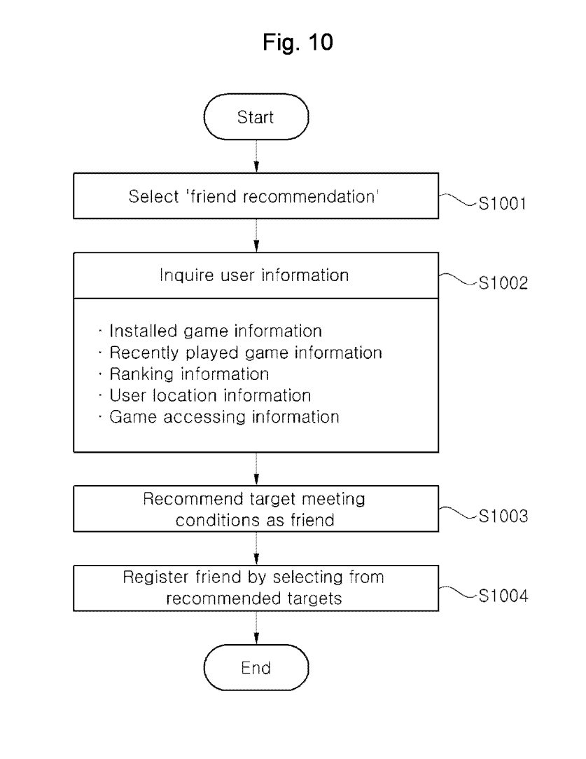

Hereinafter, a system according to an exemplary embodiment of the present invention and various components thereof will be described in detail with reference to FIG. 3 and FIG. 4, and then, procedures of recommending a friend and executing a game according to exemplary embodiments of the present invention will be described in detail with reference to FIG. 5, FIG. 6, FIG. 7, FIG. 8, FIG. 9, and FIG. 10.

General System Configuration

FIG. 3 is a view showing a system for registering a friend in a game according to an exemplary embodiment of the present invention.

As shown in FIG. 3, in the general system according to the exemplary embodiment of the present invention, a service server 300 of a service provider is connected to a plurality of client terminals such as smart phones 320. A game service platform is executed on each of the plurality of client terminals 320 through a communication network 310. Here, the service server 300 may include a game service platform server 301, a game server 302, an authentication server 303, a payment server 304, an SNS server 305 and a database server 306. The game server 302 may independently perform a function for individual games so that a plurality of games can be driven through each of the client terminals 320.

First, the communication network 310 can be configured regardless of a communication form, such as a wired or wireless communication, and configured in a variety of communication networks such as a personal area network (PAN), a local area network (LAN), a metropolitan area network (MAN), and a wide area network (WAN). In addition, the communication network may be a well-known world wide web (WWW) or may use a wireless transmission technique used for short range communications, such as the Infrared Data Association (IrDA) or Bluetooth™.

Meanwhile, according to an exemplary embodiment of the present invention, the game service platform server 301 is connected to the game server 302 and provides each of the client terminals 320 with the game service platform. Particularly, according to an exemplary embodiment of the present invention which will be described below, the game service platform server 301 provides various functions of the present invention, such as a function of registering an acquaintance as a game friend and a function of recommending a non-acquaintance as a game friend. Detailed functions of the game service platform server 301 will be described below with reference to FIG. 4.

The game server 302 may provide the client terminal 320 with programs or information related to each game to provide a user with various games, and a client terminal user may download a game application of each game from the game server 302, and install and execute the game application on the client terminal 320. That is, the game server 302 installs the game application on the client terminal 320 if the game application is not installed and updates the game application to a new version if the game application is an old version. Of course, the game application can be downloaded from a dedicated download server (not shown) or the game service platform server 301, not from the game server 302.

The authentication server 303 performs authentication on each client terminal 320 and authentication on connection to the game service platform server and on connection to a game of each client terminal 320, and the game service platform server 301 or the game server 302 provides the client terminal 320 with a variety of corresponding services depending on a result of the authentication.

Since the game server 302 containing a plurality of games may calculate a user's elapsed time and a time limit of a game and provide the client terminal 320 with a result thereof through communications with the client terminal 320, the game server 302 may be used to implement a free trial allowing the user to enjoy the game free of charge for a certain period of time or may be to implement a function allowing the user to play the game only at a predetermined time through a time basis rate. At this point, if a specific game is a premium game that is charged, the game is provided after a payment is made in due course through the payment server 304. In addition, the authentication server 303 may continuously communicate with the servers while the game is in progress in order to maintain the game, and thus the game server 302 may determine whether or not the network connection is maintained through communications with the client terminal 320.

The SNS server 305 provides social network services (SNS) such as Facebook™ of a service provider, and may provide a function of automatically recommending an SNS acquaintance through the game service platform server 301 by providing the game service platform server 301 with information on members according to an exemplary embodiment of the present invention.

On the other hand, the exemplary embodiments of the present invention may be associated with the SNS server 305 operated by the same company of the game service platform server 301 as shown in FIG. 3, or may provide a function of automatically recommending SNS acquaintances in association with SNS servers provided by other companies outside the service server 300.

The database server 306 stores a variety of information needed to provide the client terminal 320 with a game service platform and a plurality of games according to an exemplary embodiment of the present invention and provides information requested from the game service platform server 301, the game server 302, the authentication server 303, the payment server 304 and the SNS server 305. The requested information may include information related to execution of the game service platform, information related to execution of a game application, authentication information including user information, information related to a game and the like.

Here, the information related to the execution of a game application may include information needed to execute the game application, such as whether or not the game application is downloaded to the client terminal 320, the version of the game, the Internet protocol address of the game server 302 and the like. The authentication information containing user information includes information unique to a user to determine whether or not a valid user executes the game, information unique to a terminal to determine whether or not the game is executed at an authenticated user terminal 302 and the like. The information on the game may include information such as identification, a nickname, an avatar, an age, a sex, a grade, a game result, a ranking, a score and the like of the user and information on whether or not the user has passed a specific stage or whether or not the user has accomplished a specific mission, as well as information on whether or not the game is a free trial game and information on a time limit of the game.

The database server 306 may include a plurality of databases as shown in FIG. 4, and a database containing some or all of the information may be stored in the client terminal 320.

In addition, although not shown, a ranking server to manage a mission or a score accomplished by the user in a game may be included in the game service platform server 301 or the game server 302. In such case, a person skilled in the art would appreciate that the database server 306 may further include information related to the ranking server. Although it is described in this exemplary embodiment that the service server 300 includes six specific servers 301 to 306, the six servers may be functionally integrated or separated. In addition, some of the servers performing a part of the functions may be omitted, and some servers having additional functions may be additionally included as described above, and thus the service server 300 may include one or more servers, rather than six servers.

Meanwhile, the client terminal 320 according to an exemplary embodiment of the present invention includes an input-output function for communication with the service server 300 through the communication network 310 so that a user may execute a game service platform or a variety of games, and any kind of digital devices equipped with a memory and mounted with a microprocessor and thus having a processing capability, such as a desktop computer, a notebook computer, a workstation, a palmtop computer, a personal digital assistant (PDA), or a web pad, as well as a mobile communication terminal including a smart phone, may be adopted as the client terminal 320 according to the present invention without limit.

Game Service Platform Server

Referring to FIG. 4, according to an exemplary embodiment of the present invention, the game service platform server 301 may include a member management module 410, a game association module 420, a friend management module 430, and an additional function processing module 440. In addition, the database server 306 for storing and transmitting a variety of data in association with the game service platform server 301 may include a member information database 451, a game information database 452, a friend information database 453, and a record information database 454.

The member management module 410 manages a variety of personal information registered when a user joins a game service platform or an individual game as a member and particularly manages game records and information on friends registered by each member according to an exemplary embodiment of the present invention. The game association module 420 allows the game service platform server 301 to operate in association with individual games of the game server 302, and may allow the game service platform to process login and billing of the individual games in an integrated manner. The friend management module 430 provides various functions for adding and recommending game friends according to an exemplary embodiment of the present invention. The additional function processing module 440 provides a variety of functions that can be additionally provided in relation to addition and recommendation of game friends.

At this point, all or some of detailed function units included in each module 410 to 440 of the game service platform server 301 may also be equally included in a service platform client application installed on the client terminal 320, and some of the detailed function units may be processed in an associated or distributed manner by a server and client system.

Hereinafter, detailed functions of each of the modules will be described in detail.

First, the member management module 410 may include a member information management unit 411, a member authentication processing unit 412, a friend registration management unit 413, and a game record management unit 414. The member information management unit 411 stores a variety of information related to a member inputted when each user accesses the game service platform server 301 and joins a service through the game service platform or updates a variety of information related to the member modified through my information home (see FIG. 2) of the game service platform within the member information database 451.

The member authentication processing unit 412 performs authentication in association with the authentication server 303 when a user who has joined as a member logs in the game service platform or a game. The friend registration management unit 413 performs a function of managing game friends of a member registered in a variety of methods according to an exemplary embodiment of the present invention. The game record management unit 414 performs a function of managing records of each game or records of all games of a member.

The game association module 420 may include an individual game connection unit 421, a login management unit 422, a billing process unit 423, and a game software (S/W) installation unit 424. The individual game connection unit 421 performs an interface function of allowing a user to access a specific game when the game is selected among a plurality of games provided in the game server 302 that is associated with the game service platform server 301. The login management unit 422 performs a function of processing logging into a game in an integrated manner or individually processing logging into each game when a user accesses the game through the game service platform. The billing process unit 423 performs a function of processing billing in association with the payment server 304 when an accessed specific game is a premium game. The game S/W installation unit 424 performs a function of automatically proceeding to a game S/W installation step and installing a game S/W when a user desires to access a specific game through the game service platform according to an exemplary embodiment of the present invention and S/W corresponding to the game is not installed on the client terminal 320.

The friend management module 430 may include an address book friend addition unit 431, an SNS friend addition unit 432, a friend addition counterpart search unit 433, an ID/nickname search unit 434, and a non-acquaintance recommendation processing unit 435 so as to perform a function according to each exemplary embodiment of the present invention. The address book friend addition unit 431 performs a function of searching for an address book stored in the client terminal 320 and automatically registering searched acquaintances as game friends as shown in FIG. 6, which will be described below. The SNS friend addition unit 432 performs a function of searching for SNS friends registered by the user of the client terminal 320 from an SNS service such as Facebook™ service where the user has joined and automatically registering the searched SNS friends as game friends as shown in FIG. 7, which will be described below. The friend addition counterpart search unit 433 performs a function of searching for users who have registered the user of the client terminal 320 as a game friend and registering the searched users as game friends as shown in FIG. 8, which will be described below. The ID/nickname search unit 434 performs a function of searching for a user who has joined the game service platform or an individual game as a member using an ID or a nickname and providing a result of the search so as to register the searched user as a game friend as shown in FIG. 9, which will be described below. The non-acquaintance recommendation processing unit 435 performs a function of searching for and recommending non-acquaintances unknown to the user among service members of a game based on a predetermined algorithm (or rules) and registering non-acquaintances selected among the recommended non-acquaintances by the user as game friends as shown in FIG. 10, which will be described below.

In this manner, each function unit of the friend management module 430 provides a function of registering an acquaintance or a non-acquaintance as a game friend or a function of recommending a friend who will play a game together with the user in a variety of methods according to an exemplary embodiment of the present invention.

The additional function processing module 440 may include an SMS transmission processing unit 441, a note transmission processing unit 442, and an advertisement providing unit 443 in order to provide functions added to the functions of the friend management module 430 or a variety of additional functions provided by the game service platform according to an exemplary embodiment of the present invention. As shown in FIG. 6, which will be described below, the SMS transmission processing unit 441 performs a function of automatically transmitting an SMS invitation if an acquaintance stored in the address book is not joined a game service or provides a function of transmitting an SMS message to a friend registered by the user while the user performs a variety of functions through the game service platform. Although an exemplary embodiment of the SMS transmission processing unit 441 which transmits an SMS message is described for the convenience of explanation, it would be appreciated that the SMS transmission processing unit 441 may be applied in a variety of ways, such as transmitting an email to an electronic mail address, other than the SMS, depending on an address form of the acquaintance stored in the address book. The note transmission processing unit 442 provides a game note transmission function included in the main menu when the game service platform is executed as shown in FIG. 2. The advertisement providing unit 443 performs a function of providing information or advertisements related to a variety of games associated through the game service platform.

Meanwhile, a variety of functions included in the game service platform server 301 in relation to the exemplary embodiments of the present invention operate in association with a game service platform client application installed on the client terminal 320 to drive the game service platform. Alternatively, some of the functions are included in the game service platform client application of the client terminal 320, and the client terminal 320 autonomously drives and provides corresponding functions without operation of a server, or the client terminal 320 is provided with information on the functions of the game service platform server 301 from the game service platform server 301 and dominantly performs corresponding functions.

For example, if the user selects an address book friend addition function from a game service platform screen after a game service platform application is installed and executed on the client terminal 320, the client application directly reads address book data stored in the client terminal 320 and transmits the read address book data to the game service platform server 301. Then, the game service platform server 301 determines whether or not a user has joined as a member by comparing the address book data with member information stored in the member information database 451 and transmits a result of the determination to the client terminal 320, and thus the client terminal 320 may automatically register the user as a friend. In this manner, a variety of functions which will be described below according to an exemplary embodiment of the present invention may be performed at a server, at a client terminal, or in association with the server and the client terminal.

Database Server

The database server 306 may include a member information database 451, a game information database 452, a friend information database 453, and a record information database 454. The database server 306 may further include other databases needed to provide the game service platform according to an exemplary embodiment of the present invention.

The member information database 451 stores a variety of information on members who have joined as a service member or a game member through the game service platform. For example, the member information may include personal identification information of a corresponding member, a picture needed for profile information, a nickname, recently played games, installed games, information on a result or a record of each game, ranking information, information on challenging tasks, information on joined SNSs, information on settings of personal information exposure, information on settings of automatic login, and the like.

The game information database 452 stores information on a plurality of games associated with the game service platform server 301. For example, the game information may include information on software installed for each game, information on firm-up software, information on a version of each game, information on a record of each game, information on a challenging task of each game, information on a channel for connection to the game service platform server 301, and information on a member who has joined a corresponding game.

The friend information database 453 stores a variety of information related to a game friend automatically registered or registered by the user himself or herself according to an exemplary embodiment of the present invention. For example, the friend information may include information on an ID and a nickname of a registered friend, information on a registration channel, and information on blocked friends.

The record information database 454 stores a variety of records according to a result of a game played by each member. For example, the records information may include the number of rounds played in each game, a score of a member in each game, a score of a challenging task, and the like.

General Service Procedure

FIG. 5 is a flowchart illustrating a procedure of registering a friend in a game according to an exemplary embodiment of the present invention. First, a user of the client terminal 320 such as a smart phone downloads and installs game service platform software (step S501) and drives the installed game service platform (step S502). If the game service platform is driven and a step of joining the user as a member and logging into the game service platform is performed (step S503), a main screen is displayed on the client terminal 320 in the form as shown in FIG. 2.

At this point, according to an exemplary embodiment of the present invention, the user executes a friend addition menu (step S504) and performs registration of a friend in a variety of methods in a submenu of the friend addition menu.

For example, it is possible to automatically add a friend from the user's address book (see FIG. 6), automatically add an SNS friend (see to FIG. 7), search and add a person who has registered the user (see FIG. 8), search and add a friend using an ID/nickname (see FIG. 9), or add a friend from a list provided on a user information window or provided by non-acquaintance recommendation (see FIG. 10).

If registration of a friend is completed as described above, the user may search for a list of members registered as game friends using the client terminal 320 (step S505). If a member in the member list provided as a result of the search accesses a specific game, the game currently accessed by the member can be indicated using a game image of the specific game accessed by the member or using another method. If the user selects a specific game from the list in a method of selecting a corresponding game image displayed for the member accessing the specific game or a corresponding member (step S506), game selection information including information on the game selected by the user is transmitted to the game service platform server 301, and the game service platform server 301 provides information needed for the user to immediately access and play the selected specific game based on the transmitted game selection information.

On the other hand, if the selected game is already installed on the client terminal 320 (step S507), the game can be immediately executed (step S509). However, if the game is not installed, the screen is switched to an installation menu of the game, and a game program is downloaded and installed (step S508).

In this manner, a state in which a member registered as a game friend accesses the specific game is confirmed, and if the friend is in a state in which the friend accesses the game such as in an online state, the user may immediately participate in the game through an interface provided by the game service platform according to an exemplary embodiment of the present invention. In this manner, the user may enjoy the same game together with a registered game friend or play the same game in cooperation or in competition with each other.

Hereinafter, a procedure of registering a game friend according to a variety of exemplary embodiments will be described with reference to FIG. 6, FIG. 7, FIG. 8, FIG. 9, and FIG. 10.

Procedure of Registering a Game Friend

FIG. 6 is a flowchart illustrating a procedure of automatically registering a friend from an address book according to an exemplary embodiment of the present invention. Referring to FIG. 6, if a user selects the ‘addition of friend from address book’ menu (step S601) in the friend addition step of FIG. 5 (step S504), friend registration request information containing information indicating selection of the ‘address book friend addition’ menu is transmitted to the game service platform server 301, and the game service platform server 301 searches for the address book of the client terminal 320 that has transmitted the friend registration request information or an address book list stored in the service server 300 (step S602). The searched targets are automatically registered as game friends (step S605).

On the other hand, if a user among the searched targets is not joined a game service, registration of a friend may not be automatically performed. Accordingly, it may be confirmed whether or not a target of the game friend registration has joined a game service (e.g., a service provided through the game service platform or an individual game service) (step S603). At this point, whether or not the target has joined a game service can be confirmed by inquiring the member information database 451 through the service server 300.

As a result of the confirmation (step S604), the user who has already joined the game service is automatically registered as a game friend (step S605) as described above, and a short message service (SMS) invitation advising the user who has not joined the game service yet to join the game service is transmitted to the phone number registered in the address book (step S606). As described above, the exemplary embodiments of the present invention may be implemented to transmit various types of invitations to various forms of addresses registered in the address book, in addition to the phone number.

The SMS invitation may include link information that can directly connect to a corresponding game service join screen. Accordingly, a user receiving the SMS invitation joins the game service by selecting the link included in the SMS invitation, and the user can be additionally registered as a game friend as the user joins the game service.

This procedure can be performed in association with the game service platform client application installed on the client terminal 320 and the address book friend addition unit 431 of the friend management module 430 included in the game service platform server 301 of the service server 300.

FIG. 7 is a flowchart illustrating a procedure of automatically registering an SNS friend according to an exemplary embodiment of the present invention. Referring to FIG. 7, if the user selects the ‘addition of SNS friend’ menu (step S701) in the friend addition step of FIG. 5 (step S504), friend registration request information containing SNS account information of the user (e.g., including information needed to log into an social network service, such as a name or an URL of the social network, or a user ID or a password) and information indicating selection of the SNS friend addition menu is transmitted to the game service platform server 301, and the game service platform server 301 performs connection to the SNS such as Facebook™ where the user of a corresponding client terminal 320 has joined and authentication on the SNS user account based on the user account information contained in the received friend registration request information (step S702). If authentication on the SNS user account is completed, SNS friends registered by the user are searched for (step S703). At this point, the registered SNS friends can be searched for through the SNS server 305. The searched targets are automatically registered as game friends (step S706).

On the other hand, if a user among the searched targets has not joined a game service, registration of a friend may not be automatically performed. Accordingly, it may be confirmed whether or not a target of the game friend registration has joined a game service (e.g., a service provided through the game service platform or an individual game service) (step S704). At this point, whether or not the target has joined a game service can be confirmed by inquiring the member information database 451 through the service server 300.

As a result of the confirmation (step S705), the user who has already joined the game service is automatically registered as a game friend (step S706) as described above, and an invitation or a summons (e.g., Facebook™ notification push) advising the user who has not joined the game service yet to join the game service is transmitted through a variety of functions (e.g., a push notification function, etc.) provided by the SNS service (step S707).

The invitation or summons preferably includes link information that can directly connect to a corresponding game service join screen. Accordingly, an SNS member receiving the invitation or summons joins the game service by selecting the link included in the invitation or summons, and the SNS member can be additionally registered as a game friend as the SNS member joins the game service.

This procedure can be performed in association with the game service platform client application installed on the client terminal 320 and the SNS friend addition unit 432 of the friend management module 430 included in the game service platform server 301 of the service server 300.

FIG. 8 is a flowchart illustrating a procedure by which a user registers a person, as a friend, who added the user as a friend according to an exemplary embodiment of the present invention. Referring to FIG. 8, if the user selects the ‘addition of person who registered me’ menu (step S801) in the friend addition step of FIG. 5 (step S504), friend registration request information containing information indicating selection of the ‘addition of person who registered the user’ menu is transmitted to the game service platform server 301, and the game service platform server 301 recognizes the friend registration request information and determines whether or not there is a member who has registered the user as a game friend by searching for the friend information database 453 through the friend addition counterpart search unit 433 of the friend management module 430 included in the game service platform server 301.

A result of the search is transmitted to the corresponding client terminal 320, and the client terminal 320 receives the result of the search (step S803) and displays a list of searched targets (step S804). A game friend is registered by selecting a specific member among the displayed targets (step S805).

FIG. 9 is a flowchart illustrating a procedure of registering a friend by user search according to an exemplary embodiment of the present invention. Referring to FIG. 9, the search is performed by selecting the ‘addition of friend by searching for ID or nickname’ menu in the friend addition step of FIG. 5 (step S504) and inputting a search keyword. At this point, friend registration request information containing the search keyword inputted by the user and information indicating selection of the ‘add friend by search for a member using ID or nickname’ menu is transmitted to the game service platform server 301, and the game service platform server 301 determines whether or not there is a member corresponding to the search keyword by searching the friend information database 453 using the search keyword included in the received information through the ID/nickname search unit 434 of the friend management module 430 included in the game service platform server 301.

A result of the search is transmitted to the corresponding client terminal 320, and the client terminal 320 receives and displays the result of the search (step S902). Meanwhile, if there is a registered member corresponding to the search keyword as a result of the search (step S903), a game friend is registered by selecting the member from the result of the search (step S904).

Procedure of Recommending Friend

FIG. 10 is a flowchart illustrating a procedure of recommending a friend at a server according to an exemplary embodiment of the present invention. Referring to FIG. 10, if a user selects ‘friend recommendation’ (i.e., add a friend by recommending a non-acquaintance) (step S1001) in the friend addition step of FIG. 5 (step S504), friend registration request information containing information indicating selection of the ‘friend recommendation’ is transmitted to the game service platform server 301, and the game service platform server 301 recognizes the friend registration request information and recommends specific members among registered members as targets to be added as friends based on a predetermined algorithm or rules.

At this point, in response to the selection of the ‘friend recommendation’, the non-acquaintance recommendation processing unit 435 of the friend management module 430 included in the game service platform server 301 searches the member information database 451 (step S1002) and determines members matched to the user as target game friends.

For example, the user selects members only as many as a predetermined number (e.g., 25 members) among the members matched to corresponding conditions, based on information on games installed on the client terminal 320, information on recently played games, information on game rankings, information on locations of users, information on accessing a game and the like, and recommends the selected members as target game friends (step S1003). For example, ranking information of the user is confirmed, and a specific number of currently accessing users may be selected and recommended among the users who have rankings close to the ranking of the user. That is, since it is possible to play a game with the currently accessing users, the currently accessing users are preferably recommended with a higher priority. In addition, users who have installed a game that is the same as the game installed on the client terminal 320 by the user can be recommended, or users who have recently played a game that has been recently played by the user can be recommended, or users located in the neighborhood of the user can be recommended based on the location information of the user, or users having a game accessing time zone close to that of the user can be recommended based on game accessing information of the user. It is apparent to those skilled in the art that target game friends can be recommended by compositively combining and using one or more pieces of information described above. Here, the game friends being added by such procedure are called “rival friends,” and a request to register friends among recommended friends may be called “a request for addition of rival friends.”

The recommended list is displayed on the client terminal 320, and game friends are registered by selecting specific members among the recommended targets (step S1004).

Meanwhile, a game friend can be immediately registered from the recommended list, or a game friend can be registered after executing a game accessed by a member and playing the game together with the member. At this point, the exemplary embodiments of the present invention can be implemented to automatically register a friend only by participating in a game together, or a member is registered only as a recommended target, and then the target can be finally registered as a game friend by the selection of the user when the game is over.

Example of Implementing Game Service Platform

FIG. 11 is a view showing a screen for automatically registering a friend from an address book on a smart phone according to an exemplary embodiment of the present invention. Referring to FIG. 11, if the user selects ‘addition of friend from address book’ as described above in FIG. 6, users stored in the address book of the client terminal 320 can be automatically extracted and registered as friends. At this point, as described above, members who have already joined a game service (e.g., Michelle Wie and K J Choi of FIG. 11) among the extracted users are indicated as already added as game friends, and whether or not the members are logged in can be displayed at the same time. On the other hand, the exemplary embodiments of the present invention can be implemented to transmit an SMS invitation by clicking an invitation button or automatically transmit an SMS invitation to a member who has not joined a game service yet (e.g., Karrie Webb and Tiger Woods of FIG. 11) among the extracted users.

FIG. 12 is a view showing a screen for automatically registering an SNS friend on a smart phone according to an exemplary embodiment of the present invention. Referring to FIG. 12, if the user selects ‘addition of SNS friend’ (e.g., Facebook™ friend) as described above in FIG. 7, the user's SNS ID (e.g., ‘BIGDADDY’) is searched for through user account authentication, and then SNS friends registered by the user are searched for and displayed in a list. At this point, as described above, members who have already joined a game service (e.g., Two Marlines and Sharapova of FIG. 12) among the extracted SNS friends are indicated as already added as game friends, and whether or not the members are logged in can be displayed at the same time. On the other hand, the exemplary embodiments of the present invention can be implemented to transmit an invitation or summons provided by the SNS service by clicking an invitation button or automatically transmit an invitation or a summons to a member who have not joined a game service yet (e.g., Brown Bear and Protoss of FIG. 11) among the extracted SNS friends.

FIG. 13 is a view showing a screen in which a user registers a person, as a friend, who added the user as a friend on a smart phone according to an exemplary embodiment of the present invention. Referring to FIG. 13, if the user selects ‘addition of person who registered the user’ as described above in FIG. 8, corresponding members are searched through the service server 300 and displayed in a list. At this point, the exemplary embodiments of the present invention can be implemented to automatically add the searched members as a friend or to add a member as a friend by the selection of the user after providing a list of members beforehand.

Meanwhile, in the present exemplary embodiment, since the search is performed based on the users who have already joined the game service as members, an invitation or summons advising the users to join the game service does not need to be transmitted separately as described above in the aforementioned exemplary embodiments. In addition, in the same manner, whether or not the searched members have an access to the game service can be displayed at the same time.

FIG. 14 is a view showing a screen for registering a friend by user search on a smart phone according to an exemplary embodiment of the present invention. Referring to FIG. 14, if the user selects ‘addition of friend by searching for ID or nickname’ as described above in FIG. 9, a search window for inputting a search keyword is provided, and a result of searching for members corresponding to the inputted search keyword can be provided by inputting the search keyword into the search window. At this point, the exemplary embodiments of the present invention can be implemented to automatically add the searched members as friends or to add a member as a friend by the selection of the user after providing a list of members beforehand.

FIG. 15 is a view showing a screen for recommending a friend on a smart phone according to an exemplary embodiment of the present invention. Referring to FIG. 15, if the user selects the ‘friend recommendation’ menu as described above in FIG. 10, members determined based on a predetermined algorithm or rules (e.g., currently accessing members among the members whose rankings are close to that of the user) are provided in a recommendation list. At this point, the exemplary embodiments of the present invention can be implemented to automatically add the searched members as friends or to add a member as a friend by the selection of the user after providing a list of members beforehand.

In addition, a game image 1500 of the game that a member is currently accessing and executing can be provided on the right side of the ID or nickname of the recommended member as shown in FIG. 16, which will be described later. If the provided image is selected, the user may directly access and participate in the corresponding game. At this point, as described above, if the selected game is not installed on the client terminal 320 yet, the screen is switched to an installation menu of the game, and a procedure of installing the game is performed first.

FIG. 16 is a view showing a screen for executing a game through a list of registered friends according to an exemplary embodiment of the present invention. Referring to FIG. 16, if registration of the game friends is completed in a variety of methods as described above, the list of the registered game friends can be confirmed through the ‘List of my friends’ menu. At this point, whether or not a friend accesses the game and an image of a recently played game or a currently played game can be displayed in the list of the registered game friends. If the provided game image 1500 is selected or the play game together button 1600 is clicked, the user may immediately access and participate in the corresponding game. At this point, as described above, if the selected game is not installed on the client terminal 320 yet, the screen is switched to an installation menu of the game, and a procedure of installing the game is performed first.

Meanwhile, information for receiving the method for providing a ranking of a game group may be stored in a recording medium readable by a server computer. The recording medium includes all kinds of recording media which store programs and data so as to be read by a computer system. Examples of the recording medium include read-only memory (ROM), random access memory (RAM), DVD-ROM (digital video disk ROM), a magnetic tape, a floppy disk, an optical data storage device and the like, and a medium implemented in the form of a carrier wave, such as transmission through the Internet, is included as well. In addition, the recording media are distributed to computer systems connected through a network, and codes that can be read by a computer in a distributed manner can be stored and executed using the recording media.

The exemplary embodiments according to the present invention can be implemented in a program command form that can be executed through a variety of computer means and recorded in a computer readable medium. The computer readable medium may include program commands, data files, data structures and the like in a single or combined form. The program commands recorded in the medium may be program commands specially designed and configured for the exemplary embodiments of the present invention or program commands that are publicized and available for those skilled in the art of computer software. Examples of the computer readable medium include magnetic media such as a hard disk, a floppy disk and a magnetic tape, optical media such as a CD-ROM and a DVD, magneto-optical media such as a floppy disk, and hardware devices specially configured to store and execute the program commands, such as ROM, RAM and flash memory. Examples of the program commands include high-level language codes that can be executed by a computer using an interpreter or the like, as well as machine codes such as those generated by a compiler. The hardware devices may be configured to operate as one or more software modules in order to perform operations of the exemplary embodiments of the present invention, and vice versa.

While exemplary embodiments of the present invention has been described in connection with the exemplary embodiments illustrated in the drawings, they are merely illustrative embodiments, and the invention is not limited to these exemplary embodiments. It is to be understood that various equivalent modifications and variations of the exemplary embodiments can be made by a person having an ordinary skill in the art without departing from the spirit and scope of the present invention. Therefore, the true technical scope of the present invention should be defined by the technical spirit of the appended claims.

What is claimed is:

1. A method of registering a friend in a game, performed by a game service platform server, the method comprising:
receiving from a user terminal of a user, friend registration request information of a member among members who have joined a game managed by the game service platform server;
registering, by the game service platform server, the member as a game friend of the user, based on friend registration request information;
providing the user terminal with game selection information indicating that the registered game friend has selected a game, the game currently being accessed by the registered game friend; and
providing the user terminal with information needed to execute the game, in response to receipt of game selection information from the user terminal.

2. The method as claimed in claim 1, wherein the step of registering the member as the game friend comprises:
in response to a recognition that a request for registering a game friend from an address book based on the friend registration request information,
searching for address book data stored in the user terminal;
determining if a search target registered in the searched address book data has joined a game service; and
registering the search target as the game friend, in response to the determination that the search target has joined the game service.

3. The method as claimed in claim 2, further comprising transmitting a message requesting the search target to join the game service to an address of the search target stored in the address book data, in response to the determination that the search target has not joined the game service.

4. The method as claimed in claim 1, wherein the step of registering the member as the game friend comprises:
in response to the recognition of a request for registering a game friend from a social network service based on the friend registration request information,
accessing the social network service based on social network service account information contained in the friend registration request information, and searching for information on a social network service friend registered in the social network service of the user;
determining if the social network service friend has joined a game service, based on the searched information on the social network service friend; and
registering the social network service friend as the game friend, in response to the determination that the social network service friend has joined the game service.

5. The method as claimed in claim 4, further comprising transmitting a message requesting the social network service friend to join the game service through a function provided by the social network service with reference to the information on the social network service friend, in response to the determination that the social network service friend has not joined the game service.

6. The method as claimed in claim 1, wherein registering the member as the game friend comprises:
in response to the recognition of a request for registering a game friend using a keyword based on the friend registration request information,
providing the user terminal with a result of searching for information on a member who has a keyword contained in the friend registration request information as an ID or a nickname; and
in response to a selection of any one of the members from the provided search result, registering the selected member as the game friend.

7. The method as claimed in claim 1, wherein registering the member as the game friend comprises:
in response to the recognition of a request for registering a non-acquaintance friend based on the friend registration request information,
extracting information on a recommendable member corresponding to conditions of a predetermined recommendation algorithm among members who have joined the game service, and providing the user terminal with information on the recommendable member; and
in response to a selection of a member from the provided member information, registering the selected member as the game friend.

8. The method as claimed in claim 7, wherein the predetermined recommendation algorithm selects the recommendable members associated with at least one of information on games installed by the user, information on recently played games, information on rankings, information on locations, and information on accessing the game.

9. A method of executing a game through registration of a friend, performed by a game service platform server managing games, the method comprising:
receiving a request for registering a game friend based on an address book from a user terminal;
searching for address book data stored in the user terminal;
determining, by the game service platform server, whether or not each search target registered in the searched address book data has joined a game service among the games managed by the game service platform server; and
registering the search target as the game friend, in response to the determination that the search target has joined the game service.

10. The method as claimed in claim 9, further comprising transmitting a message requesting the search target to join the game service to an address of the search target stored in the address book data, in response to the determination that the search target has not joined the game service.

11. A method of executing a game through registration of a friend, performed by a game service platform server managing games, the method comprising:
receiving a request for registering a rival friend from a user terminal;
extracting information, by the game service platform server, on a recommendable member corresponding to conditions of a predetermined recommendation algorithm among the members who have joined a game service among games managed by the game service platform server, and providing the user terminal with the information on recommendable members; and
in response to a selection of a member from the recommendable member information, registering the selected member as the game friend.

12. The method as claimed in claim 11, wherein the recommendation algorithm selects the recommendable members associated with at least one of information on games installed by the user, information on recently executed games, information on locations, and information on accessing the game.

13. A system for registering a friend in a game, the system comprising:
a user terminal configured to execute a game service platform which manages the game and provides friend registration request information and game selection information through the game service platform; and
a game service platform server configured to provide, to the user terminal, friend registration request information of a member among members who have joined a game managed by the game service platform server, to register the member as a game friend of the user, based on the friend registration request information, to provide the user terminal with game selection information indicating that the registered game friend has selected a game, the game currently accessed by the registered game friend, and to provide the user terminal with information needed to execute the game, in response to a receipt of the game selection information by the user terminal.

14. The system as claimed in claim 13, wherein the game service platform server comprises an address book friend addition unit configured to:
in response to the recognition of a request for registering a game friend from an address book based on the friend registration request information,
search for address book data stored in the user terminal;
determine if a search target registered in the searched address book data has joined a game service; and
register the search target as the game friend in response to the determination that the search target has joined the game service.

15. The system as claimed in claim 14, wherein the address book friend addition unit is configured to transmit a message advising the search target to join the game service to an address of the search target stored in the address book data, in response to the determination that the search target has not joined the game service.

16. The system as claimed in claim 13, wherein the game service platform server comprises an social network service (SNS) friend addition unit configured to, in response to the recognition of a request for registering a game friend from a social network service based on the friend registration request information, access the social network service based on social network service account information contained in the received friend registration request information, and search for information on a social network service friend registered in the social network service of the user, determine whether or not the social network service friend has joined a game service, and register the social network service friend as the game friend, in response to the determination that the social network service friend has joined the game service.

17. The system as claimed in claim 16, wherein the SNS friend addition unit is configured to transmit a message requesting the social network service friend to join the game service through the social network service with reference to the information on the social network service friend, in response to the determination that the social network service friend has not joined the game service.

18. The system as claimed in claim 13, wherein the game service platform server comprises an name search unit configured to, in response to the recognition of a request for registering a game friend using a keyword based on the friend registration request information, provide the user terminal with a result of searching for information on a member who has a keyword contained in the received friend registration request information as an ID or a nickname, and in response to a selection of any one of the members from the provided search result, register the selected member as the game friend.

19. The system as claimed in claim 13, wherein the game service platform server comprises a non-acquaintance recommendation processing unit for, in response to the recognition of a request for registering a non-acquaintance friend based on the friend registration request information, extracting information on at least one recommendable member corresponding to conditions of a predetermined recommendation algorithm among the members who have joined the game service, and providing the user terminal with the information on recommendable members, and in response to a selection of a member from the recommendable member information, registering the selected member as the game friend.

20. The system as claimed in claim 19, wherein the recommendation algorithm selects the recommendable members associated with at least one of information on games installed by the user, information on recently played games, information on rankings, information on locations, and information on accessing the game.

21. A game service platform server providing a plurality of games associated with a plurality of game server, the game service platform server comprising:
a first server storing member information comprising game platform service account information of users, game installation information indicating whether a game provided by at least one of the plurality of game servers is installed on user devices of each of the users, and friend information of each of the users; and
a second server, in response to a request for service of a game of the plurality of games from one of the user devices, referring to the friend information of a user of the user device and game installation information for other user devices of other users included the friend information referred to and transmitting a friend list to the one of the user devices for generating rank information based on game results received from the game server,
wherein the other users included in the friend information are classified base on whether the game is installed on user devices of the other users.

22. The system of claim 21, wherein the second server, in case that the game is not installed in the second user device, transmits an invitation message to the second user device.

23. The system of claim 22, wherein the invitation message comprises a link information for installing the game

24. The system of claim 23, wherein the game platform service account information is an account information of a social network service the user subscribes.
